(19) United States
(12) Patent Application Publication
(10) Pub. No.: US 2016/0052460 A1
(43) Pub. Date: Feb. 25, 2016

(54) Container, in Particular for Installing in a Liftgate of a Motor Vehicle

(71) Applicant: DAIMLER AG, Stuttgart (DE)

(72) Inventor: Alexander STORZ, Stuttgart (DE)

(73) Assignee: Daimler AG, Stuttgart (DE)

(21) Appl. No.: 14/781,274

(22) PCT Filed: Feb. 22, 2014
(86) PCT No.: PCT/EP2014/000470

§ 371 Date: Sep. 29, 2015

(30) Foreign Application Priority Data
Mar. 30, 2013 (DE) 10 2013 005 535.0

(51) Int. Cl. B60R 9/06

(52) U.S. Cl. CPC B60R 9/06

(57) ABSTRACT

A container, in particular for integrating into a tailgate of a motor vehicle, is disclosed. The container has a container lower part which is able to be attached to the tailgate and having a container cover which is able to be connected or is connected to the container lower part for the selective opening or closing of the container lower part. The container cover is connected to the container lower part via a joint arrangement by which the container cover is able to be arranged at at least two different distances to the container lower part such that a height of the container is able to be adjusted.

### BACKGROUND AND SUMMARY OF THE INVENTION

The present invention relates to a container, in particular for installing in a tailgate of a motor vehicle, as well as a tailgate of a motor vehicle having such a container. The present invention furthermore relates to a motor vehicle having such a tailgate.

Loading compartments of motor vehicles can usually be closed using a pivotable tailgate. In particular in small cars, the stowage space provided by such a loading compartment is, however, limited. Therefore, in the case of small cars, it is often usual to provide a container to receive additional goods to be stored in the pivotable tailgate. Such a container is usually suitable to receive goods to be stowed having limited spatial dimensions, such as, for example, a tool, a first aid box, among other things. Such goods to be stored having relatively small outer dimensions can be stowed without a problem in a container integrated into the tailgate, such that the stowage space remaining in the loading compartment can be used completely as a stowage volume for bulky objects.

A disadvantage of conventional containers which are integrated into a tailgate consists, as explained above, in that the container is not suitable to receive bulky objects. As the tailgate itself has a low construction height, a container integrated completely into the tailgate only allows the receiving of objects with a limited height.

DE 195 22 296 C2 discloses a vehicle having a vehicle body, a loading compartment provided therein and limited from below by a loading floor, and having a divided rear door which closes the loading compartment at the back side. A door lower part of the rear door is held on the rear edge of the loading floor to be pivotable around a pivot axis which runs transversely by means of a hinge. The loading floor is formed as a base plate which is fixed releasably to the vehicle body and is able to be removed and has an adjusting clearance for the adjustment of the rear door lower part. The hinge is formed to be integrated into the base plate and into the door lower part and to extend over the entire width thereof in such a way that it substantially seals the separation point between the door lower part and the base plate.

The present invention is concerned with the problem of specifying an improved embodiment for a container, in particular for integrating into a tailgate of a motor vehicle.

This problem is solved by the subject matter of the independent claims. Preferred embodiments are subject matter of the dependent claims.

The invention is based on the general concept of providing a container which is suitable for integration into a tailgate of a motor vehicle, having a container lower part which is able to be attached to the tailgate and a container cover which is connected to the container lower part for the selective opening or closing of the container lower part, where the container cover is connected to the container lower part via a joint assembly. The joint assembly is thus formed according to the invention in such a way that the container cover is able to be arranged at at least two different distances to the container lower part, such that a height of the container is able to be adjusted. In this way, objects having different outer dimensions, in particular having different object heights, can be stowed in a stored manner in the container according to need.

The objects stowed in the container can be removed again from the container by a simple opening of the container cover. In the case that no or small objects are stored in the container, the container cover is arranged at the shortest of the two distances to the container lower part, such that the spatial volume required by the container is as small as possible. To receive bulky objects, the container cover can be adjusted in a simple manner to the larger of the two distances, such that the height of the container is larger when arranging the container cover relative to the container lower part at the shorter of the two distances. Depending on which outer dimensions the objects to be received in the container have, the height of the container can therefore be adapted accordingly.

In a preferred embodiment, the joint arrangement can include at least one three-joint, preferably two three-joints, having a first and second jointed arm. Here, the first jointed arm is connected to the container cover by means of a first joint and the second jointed arm is connected to the container lower part by means of a second joint. The two jointed arms are finally connected to each other by means of a third joint. The ability to adjust the container cover can be implemented by means of such a joint arrangement in a technically simple and thus cost-effective manner in such a way that it is able to be arranged at at least two different distances to the container lower part.

Preferably, the container cover is pivotable between an open position in which it releases the container lower part for loading or unloading of goods to be stored, and a closed position in which it closes the container lower part, by means of the at least one three-joint. Thus, an opening of the container cover can be implemented by means of the three-joint, as well as the ability to adjust of the container cover with respect to the container lower part with different heights of the container simultaneously, which allows a convenient stowage or removal of goods to be stored in the container lower part.

In an advantageous development, the at least one three-joint is able to be adjusted between a first, second and third position, wherein the container cover is situated in the first position of the three-joint in the open position. On the other hand, the container cover is situated in the second and third position of the three-joint in the closed position, where the container has a greater height in the second position of the three-joint than in the third position. Such an ability to adjust between three positions enables a particularly simple loading or a removal of goods to be stored in the container, where at the same time, the required container height can be adapted in a simple manner to the spatial dimensions of the goods to be stored which are stowed in the container. In the case that no goods to be stored are situated in the container, it is offered to adjust the three-joint into the third position in which the container cover closes the container lower part and the height of the container is thus at a minimum.

In an embodiment which is technically particularly simple to produce, the at least one three-joint can be formed in the manner of a folding hinge. As such folding hinges are commercially available in large quantities, the production costs of the container can be further reduced by using a three-joint formed as a folding hinge.

Preferably, the joint arrangement includes a stop element, by means of which the container cover is able to be locked or is locked to the container lower part in the open first and/or closed third position. This prevents an undesired adjustment of the container cover. Additionally, it can be prevented by means of the stop element that the container opens in an undesired manner, for example during a driving operation of the motor vehicle which is using the container, and thus the objects stowed in the container can fall out of the container. The stop element can be adjustable in height.

In an embodiment which is technically relatively simple to implement and thus is cost-efficient, the stop element can be formed as an, in particular, rotatable and self-locking locking device, which can be locked in the first or third position.

In a particularly preferred embodiment, the locking device can include a locking element in which a complementary fixing element provided on the container cover is able to be locked or is locked. By means of such a locking device, the folding down of the three-joint into the first position and into the third position is prevented. In this way, a closing seal can be implemented in a technically particularly simple manner for the container cover on the container lower part.

In a particularly preferred embodiment, at least one stop can be provided on the joint arrangement by means of which the joint arrangement is stabilized in the closed second position. Thus the spring element enables a convenient opening of the container cover for the user of the container. For example, it can be considered that, after an opening of the closing element by the user, the container cover is moved automatically into the open position by means of the spring element using the pre-tension force caused by this.

Alternatively or additionally, a spring element can be provided on the joint arrangement by means of which the joint arrangement pre-tensions the container cover in its open position. In the case that bulky objects are stowed in the container, such a stabilizing of the joint arrangement in the closed second position enables the container to maintain the height of the container allocated to the second position and thus to not change the height of the container in an undesired manner, for example during a driving operation of the motor vehicle using the container. Alternatively or additionally, a spring element can be provided on the joint arrangement which prevents an automatic folding up of the container cover in the first and third position. Alternatively or additionally, the three-joint can furthermore be implemented geometrically in such a way that it prevents a folding up of the container cover in the third position by self-locking.

The present invention furthermore relates to a tailgate of a motor vehicle having a base element, having a swivel element attached to the base element, by means of which the base element is able to be connected to a rear region of the motor vehicle for the selective opening or closing of a rear opening of the motor vehicle provided in the rear region to be pivotable, as well as to a container attached to the upper side of the base element having one or more of the features explained above.

The invention finally relates to a motor vehicle having a rear region having a rear opening. The rear opening is able to be closed by means of the tailgate presented above.

Further important features and advantages of the invention arise from the sub-claims, the drawings and the corresponding description of the figures by means of the drawings.

It is understood that the features that are referred to above and are still to be illustrated below are not only able to be used in each specified combination, but also in other combinations or individually, without exceeding the scope of the present invention.

Preferred exemplary embodiments of the invention are depicted in the drawings and illustrated in greater detail in the description below, wherein the same reference numerals refer to the same or similar or functionally identical components.

### BRIEF DESCRIPTION OF THE DRAWINGS

Here, schematic views of the following are depicted:

FIG. 1a is a container according to the invention in an open first position,

FIG. 1b illustrates the joint arrangement of the container in the first position,

FIG. 2a illustrates the container according to the invention in a closed second position,

FIG. 2b illustrates the joint arrangement of the container in the second position,

FIG. 3a illustrates the container according to the invention in a closed third position, and

FIG. 3b illustrates the joint arrangement of the container in the third position.

### DETAILED DESCRIPTION OF THE DRAWINGS

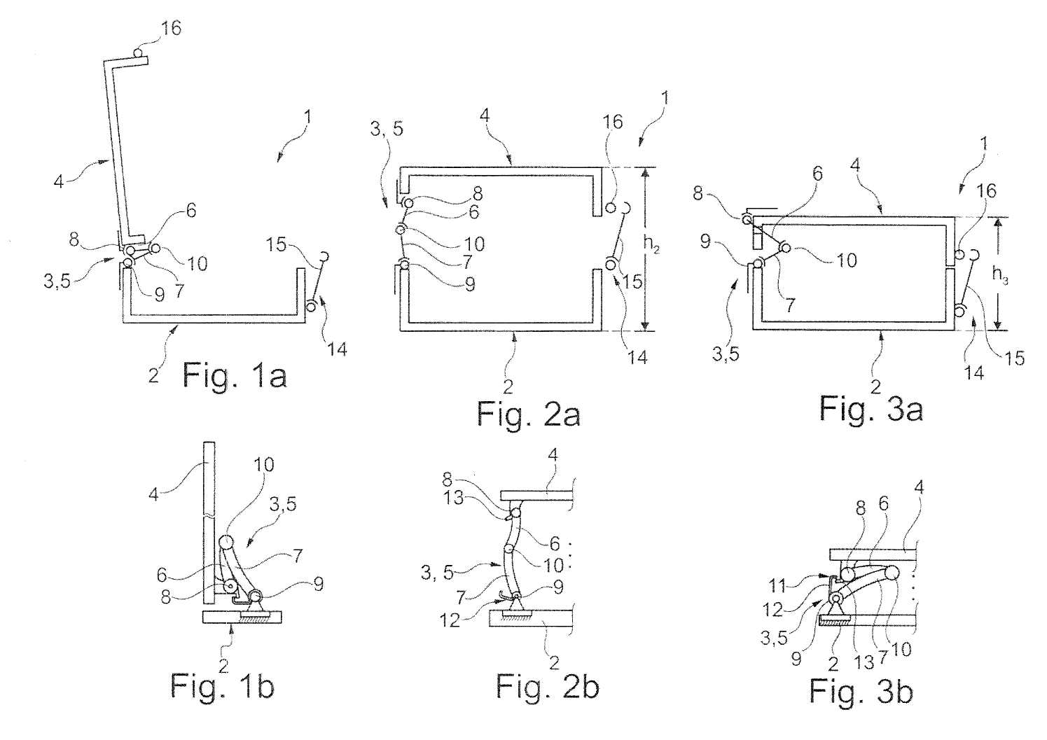

In FIG. 1a, a container according to the invention is depicted in a longitudinal section in a roughly schematic manner and is referred to with the reference numeral 1. The container 1 includes a container lower part 2 which is able to be attached to a tailgate of a motor vehicle as well as a container cover 4 which is connected to the container lower part 2 via a joint arrangement 3 having the container lower part 2. The container cover 4 can be arranged in a mechanically stable manner at at least two different distances h₂, h₃ to the container lower part by means of the joint arrangement 3 for the closing of the container lower part 2. The closed container 1 is therefore height-adjustable between the two heights h₂, h₃.

The joint arrangement 3 includes at least one three joint 5 which is depicted in FIG. 1b in a detailed view. The three-joint 5 includes a first and second jointed arm 6, 7. The first jointed arm 6 is connected to the container cover 4 supplely by means of a first joint 8. The second jointed arm 7 is connected to the container lower part 2 accordingly by means of the second joint 9. The two jointed arms 6, 7 are finally connected to each other supplely by means of a third joint 10.

FIGS. 1a and 1b show the container 1 or the joint arrangement 3 having the three-joint 5 in an open position of the container cover 4 in which this releases the container lower part 2 for loading or unloading of goods to be stowed. The container cover 4 is pivotable in two closed positions shown in FIGS. 2 and 3 by means of the joint arrangement 3 or the three-joint 5, in which it closes the container lower part 2. It can thus be gleaned from the depictions of FIGS. 1, 2 and 3 that the three joint 5 is adjustable between an open position shown in FIG. 1a/b and a second or third position shown in FIGS. 2a/b and 3a/b, wherein the container cover 4 is situated in the closed position in the second and third position of the three joint 5.

In the second position of the container 1 or the three-joint 5 shown in FIG. 2a/b, the container 1 has a greater height h₂ than in the third position in which the height of the container amounts to h₃.

Furthermore it can be gleaned from the depiction of FIGS. 1b, 2b and 3b that the three-joint 5 can be formed in the manner of a folding hinge. In the second position of the three-joint 5 shown in FIGS. 2a/b, this is therefore arranged, as is shown in FIG. 2b, in a folded-out state between the container cover 4 and the container lower part 2. On the other hand, the three joint 5 formed as a folding hinge is arranged in the third position shown in FIG. 3b in a folded-in state between the container cover 4 and the container lower part 2.

Furthermore, it can be gleaned from FIGS. 1b and 3b that the joint arrangement 3 can include a stop element 11. The container cover 4 can be locked to the container lower part 2 in the open first position shown in FIG. 1b and in the closed third position shown in FIG. 3b by means of the stop element 11. For this purpose, the stop element 11 can be formed, for example, as a locking device. Such a locking device can have a locking element 12 provided on the three-joint 5 in which a complementary fixing element 13 provided on the container cover 4 is able to be locked. In one variant, a spring element can be provided on the joint 10 which connects the two jointed arms 6 and 7 and which prevents a folding-up in the first and third position. In a further variant, the three-joint 3 can be implemented in a geometric manner in such a way that a folding-up in the third position is prevent by self-locking.

Alternatively or additionally, at least one stop which is not shown on account of clarity can be provided, by means of which the joint arrangement 3 can be stabilized in the closed second position of the container cover 4 (see FIG. 2a,b). In this way, it can be ensured that in the case that bulky objects are stored in the container 1, this is not damaged by an undesired automatic adjustment of the container cover 4 from the second position having height h₂ into the third position having lower height h₃. Instead of such a stop, further suitable devices are also able to be provided, by means of which the joint arrangement 3 can be stabilized in the closed second position.

Alternatively or additionally, a suitable device, for example in the manner of a stop, a locking device, among other things, can also be provided, by means of which the joint arrangement 3 is stabilized in the closed third position of the container cover 4 (see FIG. 3a, b). In this manner, an undesired “snapping” of the container cover 4 from the third position into the second position can be prevented.

Furthermore, a spring element which is not shown in the figures on account of clarity can also be provided by means of which the joint arrangement 3 pre-tensions the container cover 4 with respect to its open position. This facilitates an opening of the container cover 4 by a user.

In addition to the stop element 11, a separate height-adjustable closing element 14 is provided on the container 1, by means of which the container cover 4 is able to be locked in its closed second position and third position on the container lower part 2. The closing element 14 can be fixed to the container lower part 2 separately to the joint arrangement 3 and can be formed in the manner of a closing lever 15 which is able to be fixed in the closed position of the container cover 4 on a fixing element 16 provided on the container cover 4. In a simplified variant, a non-height-adjustable closing element 14 can also be implemented such that it is able to be fixed in the second position and in the third position on two different fixing elements 16 attached to the container cover 2.

In developed variants, one or more suitable stops can be provided in the container 1, in particular on the container lower part 2 or on the container cover 4, but also on the joint arrangement 3, which prevent an undesired opening of the container cover 4.

The container 1 can be part of a tailgate of a motor vehicle. Such a tailgate can comprise a base element and a pivot element attached to the base element by means of which the base element is connected to a rear region of the motor vehicle to be pivotable. In this manner, a rear opening of the motor vehicle provided in the rear region can be selectively opened or closed. Then the container 1 explained above can be attached on the upper side of the base element.

1.-10. (canceled)

11. A container for integrating into a tailgate of a motor vehicle, comprising:
a container lower part which is attachable to the tailgate; and
a container cover which is connected to the container lower part for a selective opening and closing of the container lower part;
wherein the container cover is connected to the container lower part via a joint arrangement by which the container cover is arrangeable at at least two different distances to the container lower part such that a height of the container is adjustable.

12. The container according to claim 11, wherein the joint arrangement includes at least one three-joint having a first jointed arm and a second jointed arm, wherein the first jointed arm is connected to the container cover by a first joint, wherein the second jointed arm is connected to the container lower part by a second joint, and wherein the first jointed arm is connected to the second jointed arm by a third joint.

13. The container according to claim 11, wherein the container cover is pivotable between an open position, in which the container cover releases the container lower part for loading or unloading of goods to be stored, and a closed position, in which the container cover closes the container lower part, by the joint arrangement and wherein the joint arrangement includes at least one three-joint.

14. The container according to claim 13, wherein the at least one three-joint is adjustable between a first, a second, and a third position, wherein the container cover is in the open position when the at least one three joint is in the first position, wherein the container cover is in the closed position when the at least one three joint is in the second and the third position, and wherein the container has a greater height in the second position of the at least one three joint than in the third position.

15. The container according to claim 11, wherein the joint arrangement is a folding hinge.

16. The container according to claim 11, wherein the joint arrangement includes a stop element.

17. The container according to claim 16, wherein the stop element is a rotatable and self-locking locking device.

18. The container according to claim 11, wherein a stop is disposed on the joint arrangement and/or a spring element is disposed on the joint arrangement.

19. A tailgate of a motor vehicle, comprising:
a base element;
a pivot element attached to the base element by which the base element is connectable to a rear region of the motor vehicle for selective opening or closing of a rear opening of the motor vehicle in the rear region; and
a container according to claim 11 attached to an upper side of the base element.

20. A motor vehicle, comprising:
a tailgate according to claim 19.
